(19) United States
(12) Patent Application Publication
(10) Pub. No.: US 2004/0102085 A1
(43) Pub. Date: May 27, 2004

(54) Wire-collecting device for computer accessories

(75) Inventor: Kuan-Heng Wu, Tainan City (TW)

Correspondence Address: Ladas & Parry, 26 West 61st Street, New York, NY, 10023, US

(73) Assignee: BENQ CORPORATION

(21) Appl. No.: 10/718,069

(22) Filed: Nov. 20, 2003

(30) Foreign Application Priority Data
Nov. 22, 2002 (TW) 91134117

(51) Int. Cl. H01R 13/72

(52) U.S. Cl. 439/501

(57) ABSTRACT

A wire-collecting device provided for a computer accessory is disclosed. The computer accessory has a signal-transmission device extending therefrom. The wire-collecting device includes a casing coupled to the computer accessory for storing a cable of the signal transmission device, and a fastening device for fastening a connector of the signal-transmission device.

### FIELD OF THE INVENTION

The present invention relates to a wire-collecting device provided for containing a cable of a computer accessory and, more particularly, to a wire-collecting device capable of fastening a connector of the computer accessory.

### DESCRIPTION OF THE PRIOR ART

With the technological revolution in recent years, different types of personal computers (PCs), such as a desktop type, a notebook type or the like, have been well developed and commercially available in the marketplace.

Many computer systems, including personal computers, workstations, and servers are designed to have multiple peripheral devices included in the system. Generally, a typical personal computer system includes a processor, associated memory and control logic and a number of peripheral devices that provide input and output (I/O) for the system. Such peripheral devices include, for example, compact disk read-only memory (CD-ROM) drives, hard disk drives, floppy disk drives, and other mass storage devices such as magneto optical (MO) drives, compact disk recordable (CD-R) drives or digital video/versatile disk (DVD) drives.

The major method of expanding the functional ability of personal computers can be expressed as the following: the expansion apparatus is made to be external, and connects to the personal computer via a connection device, thereby increasing the functional ability of the personal computer.

So far, the connection device is generally a wire type that electrically connects to or communicates with the computer through a cable, such as a power cord, an USB cable, or an IEEE 1394 cable etc.

Referring to FIG.1, a conventional notebook computer 10 and a plurality of external accessories with wires are shown. The external accessories can be a CD-ROM 101, a floppy disk drive 102, a DVD drive 103, a hard disk drive 104, or a CD-R drive 105. These accessories connect to the notebook computer 10 through different cables described above for expending the function of the notebook computer 10.

It is noted that, however, cables mentioned above often lead to inconvenience in carrying portable accessories. In addition, optimum lengths of the cables are not easily to be adjusted while using the accessories. Further, the collection and storage of cables extending from accessories are annoying problems to users.

### SUMMARY OF THE INVENTION

Accordingly, an object of the present invention is to provide a wire-collecting device for storing cables of computer accessories.

Another object of the present invention is to provide a wire-collecting device capable of fastening cable connectors of computer accessories.

Another object of the present invention is to provide a wire-collecting device having an elastic element to facilitate the collection of cables of computer accessories.

Still another object of the present invention is to provide a computer accessory with a wire-collecting device.

A wire-collecting device of a computer accessory has a casing, a fastening device, and an elastic element. The casing has a first opening and a collecting portion inside the casing for containing a signal-transmission device extending from the computer accessory. The fastening device is positioned on a first interior surface of the casing, and the fastening device is positioned near the first opening to fasten the signal-transmission device. The elastic element has a first terminal and a second terminal. The first terminal of the elastic element is installed into a second interior surface of the casing, and the second terminal of the elastic element is connected to the signal-transmission device to force the signal-transmission device to draw back into the collecting portion.

### BRIEF DESCRIPTION OF THE DRAWINGS

The foregoing aspects and many of the attendant advantages of this invention will become more readily appreciated and understood by referencing the following detailed description in conjunction with the accompanying drawings, wherein:

FIG. 1 is a schematic diagram illustrating a conventional notebook computer with a plurality of wire-type external accessories;

FIG. 2 is a side view of a wire-collecting device coupled to an external computer accessory in accordance with the present invention;

FIG. 3 is a perspective view of the wire-collecting device in accordance with the present invention;

FIG. 4 is a side view of a fastening device constructed on an interior surface of a casing in accordance with the present invention;

FIG. 5 is a perspective view of the wire-collecting device, showing the helical cable being clasped by a trench in accordance with the present invention; and

FIG. 6 is a perspective view of the wire-collecting device, showing a connector of the helical cable being contained in a recess in accordance with the present invention.

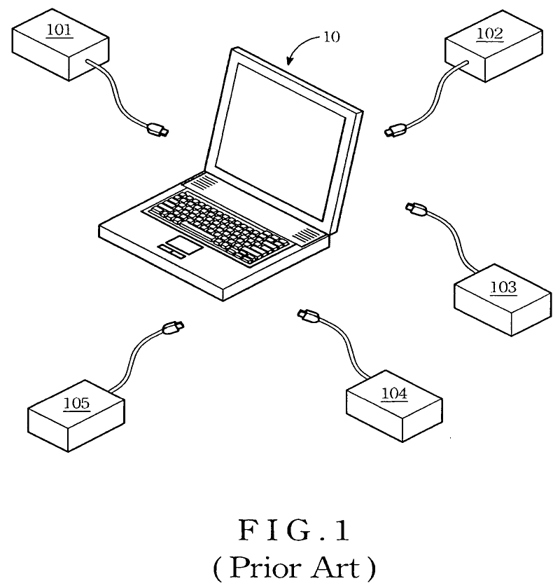

### DETAILED DESCRIPTION OF THE PERFERRED EMBODIMENTS

The invention disclosed herein is directed to a wire-collecting device provided for computer accessories, especially for external computer accessories. Much more specifically, the invention is directed to a wire-collecting device capable of fastening a cable connector of the external computer accessory. In one preferred embodiment of the present invention, the wire-collecting device is coupled to the computer accessory. In another embodiment, the wire-collecting device is fabricated to one piece with the computer accessory. The preferred embodiment of the present invention is now described in detail below.

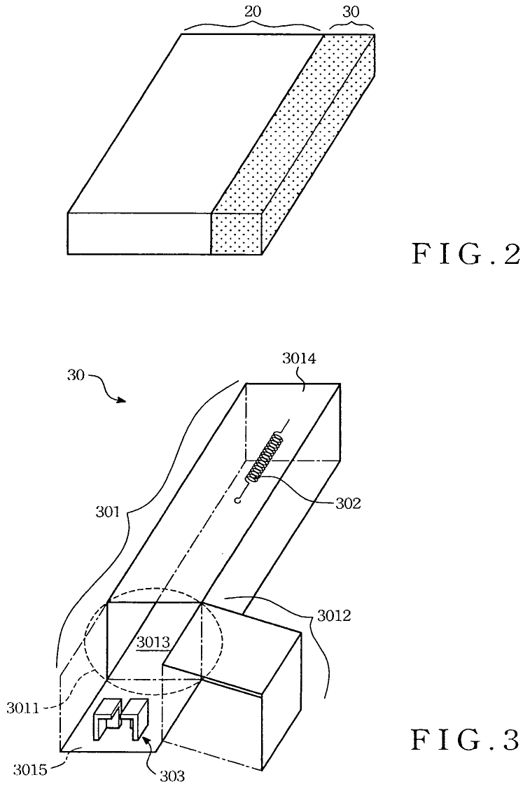

Referring to FIG. 2, an external computer accessory 20 coupled with a wire-collecting device 30, e.g. CD-ROM, CD recorder, DVD drive, hard disk drive, floppy disk drive, scanner, printer or digital camera, is shown. The computer accessory 20 has a signal-transmission device (not shown). The wire-collecting device 30 is preferably coupled to the computer accessory 20. In another embodiment, however, the wire-collecting device 30 is formed to one piece with the computer accessory 20.

Referring to FIGS. 3-5, the wire-collecting device 30 has a casing 301, an elastic element 302 and a fastening device 303. The casing 301 includes a first opening 3011, a cover 3012 and a collecting portion 3013. The cover 3012 is supplied to swing between open and closed positions relative to the first opening 3011. The fastening device 303 is positioned on a first interior surface 3015 of the casing 301. The signal-transmission device includes a cable 201 and a connector 202. The collecting portion 3013 inside the casing 301 is provided to contain the cable 201 extending from the computer accessory 20. A first terminal of the elastic element 302 is installed into a second interior surface 3014 of the casing 301, and a second terminal of the elastic element 302 is connected to the cable body. In a preferred embodiment of the present invention, the second terminal of the elastic element 302 hooks the cable 201. In addition, the elastic element 302 is a spring, and the second interior surface 3014 is opposite to the first opening 3011. The fastening device 303 constructed on the first interior surface 3015 of the casing 301 is located near the first opening 3011.

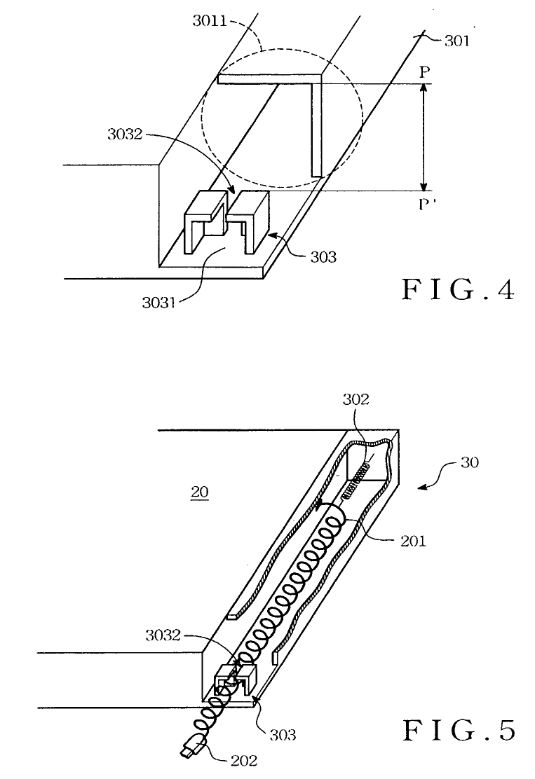

Referring to the FIG. 4, the fastening device 303 includes a recess 3031 and a second opening 3032. The recess 3031 is provided to clasp the connector 202 of the signal-transmission device, and the second opening 3032 enables the cable 201 to pass through. In a preferred embodiment of the present invention, the cable 201 is a helix cable 201. The second opening 3032 is wider than the diameter of the cable 201 and the second opening 3032 is narrower than the connector 202. The width of the second opening 3032 is smaller than a diameter of the helix cable 201 so as to clamp the helical cable while the computer accessory 20. The recess 3031 is wider than the connector 202.

Referring to FIG. 5, the signal-transmission device of the computer accessory 20 includes the cable 201 and the connector 202. When a user use the computer accessory 20, the connector 202 is drawn out of the recess 3031 firstly. Next, the cable 201 is pulled out of the fastening device 303. The cable 201 is removed back into the recess 3031 and clamped into the second opening 3032 after adjusting an optimum length thereof.

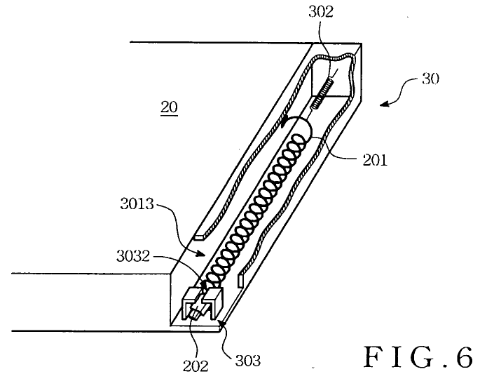

Referring to FIG. 6, the cable 201 is pulled up to leave the fastening device 303 after using. Subsequently, the cable 201 is forced to draw back into the collecting portion 3013 of the casing 301 by the elastic element 302. The cable 201 is removed into the recess 3031 by passing through the second opening 3032. Finally, the connector 202 is clasped into the recess 3031.

Referring back to FIG. 4, a distance from an interior top surface of the casing 301 to the first interior surface 3015, i.e. the distance between P and P′, is greater than a diameter of the helix cable aforementioned, thus an optimum length of the cable 201 is easily adjusted when the computer accessory 20 is used by a user.

The connector 202 is easily to be pulled out of the recess 3031 when the computer accessory is prepared to be used because the connector is clasped and extruded from the recess 3031. In addition, the wire-collecting device 30 can be manufactured into one piece with the computer accessory, so the manufacturing cost can be reduced. Further, cables of computer accessories are collected and stored in the wire-collecting device while these computer accessories are not in use, these cables will not engage with each other easily.

While the preferred embodiment of the invention has been illustrated and described, it is appreciated that various changes and modifications can be made therein without departing from the spirit and scope of the invention.

What is claimed:

1. A wire-collecting device of a computer accessory, comprising:
a casing coupled to said computer accessory having a first opening; and a collecting portion inside said casing for containing a signal-transmission device of said computer accessory; and
a fastening device positioned on a first interior surface of said casing, and said fastening device being positioned near said first opening to clasp said signal-transmission device.

2. The wire-collecting device of claim 1, wherein said casing further comprises a cover positioned out of said first opening.

3. The wire-collecting device of claim 1, further comprising an elastic element, a first terminal of said elastic element being installed on a second interior surface of said casing, and said second interior surface being opposite to said first opening.

4. The wire-collecting device of claim 3, wherein said elastic element further comprises a second terminal connected to said signal-transmission device to force the signal-transmission device draw back into said collecting portion.

5. The wire-collecting device of claim 1, wherein said signal-transmission device includes a cable and a connector.

6. The wire-collecting device of claim 5, wherein said fastening device further comprises a second opening to enable said cable to pass through, said second opening is wider than a diameter of said cable, and smaller than a width of said connector.

7. The wire-collecting device of claim 6, wherein said fastening device further comprises a recess for fastening said connector.

8. The wire-collecting device of claim 1, wherein said casing is manufactured to one piece during a process of making said computer accessory.

9. The wire-collecting device of claim 1, wherein said computer accessory is an external computer accessory.

10. A wire-collecting device of a computer accessory, comprising:
a casing having a first opening and a collecting portion inside said casing for containing a signal-transmission device extending from said computer accessory;
a fastening device positioned on a first interior surface of said casing, and said fastening device being positioned near said first opening to clasp said signal-transmission device; and
an elastic element having a first terminal and a second terminal, said first terminal of said elastic element being installed into a second interior surface of said casing, and said second terminal of said elastic element being connected to said signal-transmission device to force said signal-transmission device to draw back into said collecting portion.

11. The wire-collecting device of claim 10, wherein said casing further comprises a cover out of said first opening.

12. The wire-collecting device of claim 10, wherein said signal-transmission device includes a cable and a connector.

13. The wire-collecting device of claim 12, wherein said fastening device further comprises a second opening to enable said cable to pass through, said second opening is wider than a diameter of said cable, and smaller than a width of said connector.

14. The wire-collecting device of claim 13, wherein said mechanism further comprises a recess for fastening said connector.

15. The wire-collecting device of claim 10, wherein said computer accessory is an external computer accessory.

16. A wire-securing device provided for a computer accessory, said wire-securing device comprising:
a casing having a first opening and a collecting portion inside said casing for storing a cable of a signal-transmission device of said computer accessory; and
a fastening device positioned on a first interior surface of said casing, and near said first opening, said fastening device having a second opening and a recess, said second opening enabling said cable to pass through, and said recess being provided to fix said signal-transmission device,
wherein said signal-transmission device is drawn out of said recess, and pulled upwardly out of said fastening device by passing through said second opening when said computer accessory is used by a user, and said signal-transmission device is moved back into the fastening device and said signal-transmission device is clamped into said second opening after adjusting a optimum length of said signal-transmission device.

17. The fastening device of claim 16, wherein said signal-transmission device includes a connector and a cable, and said second opening is wider than a diameter of said cable, and smaller than a width of said connector.

18. The fastening device of claim 17, wherein said cable is a helix cable.

19. The fastening device of claim 18, wherein the width of said second opening is smaller than a diameter of said helix cable.

20. The fastening device of claim 16, wherein said casing further comprises a cover out of said first opening.
